(19) United States
(12) Patent Application Publication
(10) Pub. No.: US 2014/0122136 A1
(43) Pub. Date: May 1, 2014

(54) SOCIAL INTERACTION SYSTEM FOR FACILITATING DISPLAY OF CURRENT LOCATION OF FRIENDS AND LOCATION OF PREFERRED BUSINESSES

(71) Applicant: MADHAVI JAYANTHI, LAGUNA NIGUEL, CA (US)

(72) Inventor: MADHAVI JAYANTHI, LAGUNA NIGUEL, CA (US)

(21) Appl. No.: 14/146,730

(22) Filed: Jan. 3, 2014

Related U.S. Application Data
(63) Continuation of application No. 12/148,334, filed on Apr. 18, 2008.
Application No. 12/148,334 is a continuation-in-part of application No. 12/075,932, filed on Mar. 14, 2008.

(51) Int. Cl. G06Q 10/02; G06Q 50/00

(52) U.S. Cl. CPC G06Q 10/02; G06Q 50/01
USPC 705/5

(57) ABSTRACT

A system that manages communication between a user and a plurality of friends while it also displays current location of local branches of a user's businesses/stores of interest. A friends selection component employs user selections to present the user with a plurality of current location information associated with the plurality of friends wherein the user can express interest in a subset of the plurality of friends based on their current location. A communication management component delivers at least one of a task, a message, a content and a reference to each of the subset of the plurality of friends. A collection of the user's preferred businesses is managed. The system selectively displays a current location of a local branch of each of the user's preferred businesses on a map.

### CROSS REFERENCES TO RELATED APPLICATIONS

The present patent application is a continuation of, claims priority to, and makes reference to U.S. non-provisional patent Ser. No. 12/148,334, entitled “SOCIAL INTERACTION SYSTEM FOR FACILITATING DISPLAY OF CURRENT LOCATION OF FRIENDS AND LOCATION OF BUSINESSES OF INTEREST”, filed on Apr. 18, 2008, docket number 23711US01 (also referred to as MJ2008GPS4-U1), which in turn is a continuation-in-part of, claims priority to, and makes reference to U.S. non-provisional patent Ser. No. 12/075,932, entitled “MOBILE SOCIAL NETWORK FOR FACILITATING GPS BASED SERVICES”, filed on Mar. 14, 2008, docket number MJ2008GPS3-U1. The complete subject matter of all the above-referenced United States patent applications are hereby incorporated herein by reference, in their respective entirety.

The present patent application makes reference to U.S. non-provisional patent Ser. No. 12/070,268 entitled “MOBILE DEVICE AND SERVER FOR FACILITATING GPS BASED SERVICES”, filed on Feb. 15, 2008, docket number MJ2008GPS2-U1. The complete subject matter of the above-referenced United States patent application is hereby incorporated herein by reference, in its entirety.

The present patent application makes reference to U.S. non-provisional patent Ser. No. 12/012,859, entitled “CLIENT IN MOBILE DEVICE FOR SENDING AND RECEIVING NAVIGATIONAL COORDINATES AND NOTIFICATIONS”, filed on Feb. 5, 2008, docket number MJ2008GPS1-U1. The complete subject matter of the above-referenced United States patent application is hereby incorporated herein by reference, in its entirety.

### BACKGROUND

1. Technical Field

The present invention relates generally to a mobile device and particularly to a solution wherein locations of branches of a user's preferred stores/businesses are displayed on a map presented to a user while the user is driving/navigating.

2. Related Art

Mobile devices are becoming ubiquitous. Children carry them and so do adults. Children use them to ask their parents to come pick them up at a mall or a park. Often parents spend a lot of time trying to locate their child at a mall when they get a call for a ride. Similarly, children wait for a long time outside a mall waiting for their parents to arrive, often in inclement weather. This problem is also faced by mobile users who travel to a new country on business and pleasure and wait for a taxi pickup at an airport, outside an airport or in train stations.

Some GPS based applications provide navigational features, such as displaying driving directions (i.e., routes), Points Of Interest (POI), waypoints (such as personalized, user-specific, points on a route or along a track), etc., but they do not enable the transfer of such information to other mobile users (using other mobile devices or PCs) in real-time. They do not support receiving such information from other mobile devices either. Some users will typically copy an image of a map from a standard mapping program, usually with a highlighted route, and e-mail the bitmap image and/or directions to another user or group of users for the purpose of meeting at a specific location or POI, such as a restaurant. Alternatively, some users send route details to their friends using instant messaging (IM) software, using which they can transfer directions. However, a mobile user driving a vehicle is not likely to be using IM software on the mobile for fear of crashing or having an accident. Thus IM is not a good solution for exchanging information when driving a vehicle. Currently there are no better ways for a user to get real-time feedback from his buddies about a specific route used to get to the destination.

Some existing applications provide a method for dynamically and graphically transferring location-relevant information coupled with a spatial map. Some of these applications typically provide only one-way transfer of position information, from the mobile vehicle to the dispatcher application, either on a web-based or desktop-based program. Some mobile devices typically use location telemetry devices to transmit their location in a pre-defined manner or by request, where the dispatcher's location request is usually initiated by clicking on a Graphical User Interface (GUI) or by using a set of preferences to automatically request position updates. These preferences are based on various parameters, such as reporting location updates based on the distance traveled by the vehicle or by using various time intervals to trigger position updates either by a push or pull method relative to the telemetry device.

Some Automatic Vehicle Location (AVL) software solutions provide the ability to display moving vehicles on dynamically viewable maps. However, these solutions do not enable the user to select a vehicle on the map. Some other solutions provide a stationary representation of a vehicle in a roster list, in real-time for the purpose of sending the vehicle's location to other users. This is considered to be an ad-hoc position transfers between various parties. However, maintaining a roster list is not essential for most services and is cumbersome. Roster lists are not a proper user interface for most applications.

Some prior art solutions make it possible to select a user, device, or group of users and devices in a roster list and graphically drag-and-drop the selection onto an active map. This method significantly simplifies the process of identifying a single or group of user(s)/device(s) and mapping their location appropriately. However, maintaining rosters and making a user select from the roster is also cumbersome.

Some prior art solutions allow the user to drag a graphical representation of a location-relevant object, such as POI (i.e., restaurant, gas station, house, user, etc.), to a pre-calculated route itself or to a route planner, thus graphically altering the pre-calculated route by creating a destination point based on the dragged POI's location information. However, these solutions do not support automatically viewing current routes of multiple target (individuals carrying mobile devices, for example) on a map and interacting with them, such as sending tasks or sending audio messages that is dynamically recorded (and receiving responses back).

In some solutions, an IM software may be used to request permission from the target users to retrieve their location information. Thus, for the purpose of requesting, in real-time and in an ad-hoc environment, a target users' position information for mapping their location(s), an IM software is employed. However, mobile users who are driving vehicles are not likely to use IM software while driving. It is dangerous to be interacting over an IM software on a mobile device while driving a vehicle, and is against the law in some places.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

FIG. 1 is a perspective block diagram of a social interaction system that manages communication between a user and a plurality of friends.

FIG. 2 is a perspective block diagram showing a user navigating using a communication device wherein local branches of the user's favorite businesses/preferred stores are displayed on a map presented to the user on the communication device.

### DETAILED DESCRIPTION OF THE DRAWINGS

The present invention provides an elegant means of interaction between people who are mobile wherein the location information from a plurality of mobile devices is communicated to a mobile social networking system and GPS based services are accessed, such as a service to communicate with the users of the plurality of mobile devices using audio assisted means.

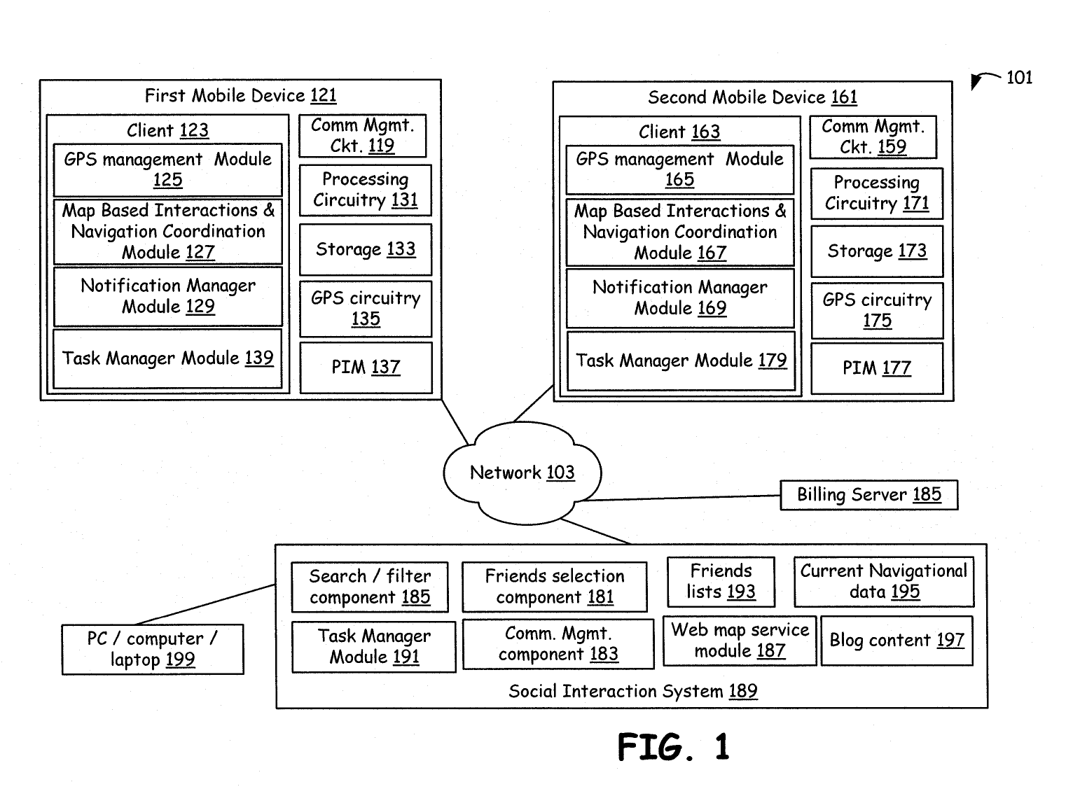

FIG. 1 is a perspective block diagram of a social interaction system 189 that manages communication between a user and a plurality of friends. The social interaction system 189 comprises a friends selection component 181 that employs user selections to present the user with a plurality of current location information associated with the plurality of friends. The user can express interest in a subset of the plurality of friends based on their current locations. The social interaction system 189 also comprises a communication management component 183 that delivers at least one of a task, a message, a content and a reference to each of the subset of the plurality of friends. The user selections identifies the plurality of friends based at least in part upon their membership in one or more friends list managed by the user. The system comprises a social interaction service that enables presentation of the plurality of friends on a map based on their current locations. Such a presentation is provided on a map displayed to the user. The system 189 also comprises a search/filter component 185 that facilitates generation of the plurality of friends, wherein the criterion for generation comprises at least one policy or preference.

The social interaction system 189 comprises a web map service module 187 which serves as a means for presenting a plurality of friends to a user on a map presented to the user. The friends selection component 181 is used for detecting selection by the user of at least one of the plurality of friends. The communication management component 183 facilitates notifying the selected ones of the plurality of friends of the selection by the user. It also facilitates communicating one of a content, a task and a message from the user to the selected ones of the plurality of friends. In addition, it facilitates receiving a response provided by the selected ones of the plurality of friends to the user and notifying the user of the responses received.

The response received by the user from one or more of his friends comprises at least one of a digital image, an audio response, a video recording, a reference to a blog entry and a document. A task manager module 191 facilitates identification of an appropriate task or selection of a task and its delivery to one or more friends from the social interaction system 189. For example, a friend may respond to a task received from the user with an audio response (a voice message for example, that is recorded and communicated to the user via the system 189).

The communication management component 183 facilitates transmission of a plurality of messages between the user and the at least one of the plurality of friends that a user may have maintained in a list of friends. It also makes it possible for the user to receive a response content from each of the plurality of friends, the response comprising at least one of a digital image, an audio response, a video recording and a document. The social interaction system 189 makes it possible to selective store the responses and associated content received.

In general, the social interaction system 189 also comprises means for displaying each of the plurality of friends as a graphical icon on a map. A different graphical icon is used to represent a corresponding one of the plurality of friends on the map, such as based on their current location, that is dynamically determined. It also comprises means of sending, in response to a command signal, the user's current location information to at least one of the plurality of friends. Such communication are often accompanied by a request to the recipient to navigate to the user's current location. The command signal is generated by the user employing a button, a menu item, a user selectable icon, etc.

In general, a mobile device or a laptop (or a PC) is associated with the user, and the user's location is determined/monitored by the mobile device or laptop. A map showing the plurality of friends is presented to the user on the mobile device or laptop (for example). The user can interact with the plurality of friends employing the mobile device. In one embodiment, the user and each of the plurality of friends interact employing mobile devices 121, 161 communicatively coupled to each other via the social interaction system 189. In a related embodiment, each of the plurality of friends interact with the user employing a corresponding one of a plurality of mobile devices 121, 161 communicatively coupled to the social interaction system 189. In one embodiment, each of the plurality of mobile devices is one of a cellular phone, a PDA, a GPS-based mobile unit, a notebook computer and a hand held device.

The mobile devices 121 and 161, or communication devices built in accordance with the present invention in general, are capable of receiving a map information and displaying the map for a user. Such devices facilitate communication with other devices or with other users on PCs/laptops with the help of the social interaction system 189. These communication devices 121, 161 comprise a processor, a data storage medium, an input unit, and a display unit for providing a graphical interface, said graphical interface including a movable graphical pointer for selecting and moving graphical icons displayed on the graphical interface. The communication devices 121, 161 are used for displaying a plurality of graphical icons on a map presented to the user, wherein, each of the plurality of graphical icons represent one of a plurality of friends. The user can select as targets at least one of the plurality of friends by choosing one or more of the plurality of graphical icons. In response to a command signal provided by the user, the communication devices 121, 161 send to the targets, at least one of a task, a location information, an audio message, a video message, a document, a content and a reference to a content.

In one exemplary embodiment, the user using a mobile device to determine where his plurality of friends are currently located views their current locations based on a dynamically retrieved location information that is received from the mobile devices currently being used by those friends. The user can then select one or more of them, and employ a command signal to communicate with them or interact with them. For example, a command signal is generated by moving a graphical pointer on a display that presents the map to select a button after selecting the targets who are the subsets of the plurality of friends the user intends to interact with. The locations of the plurality of friends are displayed on the map employing a plurality of graphical icons on the map, based on a current location determined for each of the plurality of friends. The displaying of a graphical representation of a map is facilitated by the social interaction system 189. It receives a current location information associated with the plurality of friends, from mobile devices currently being used by each of the plurality of friends.

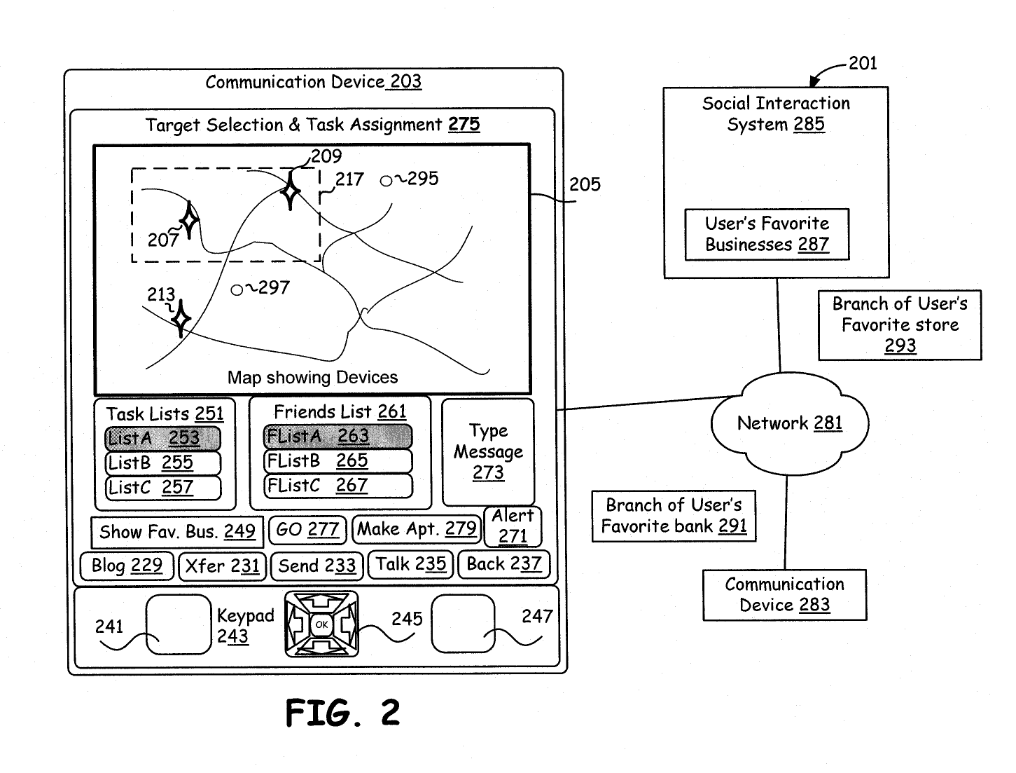

FIG. 2 is a perspective block diagram showing a user navigating using a communication device 203 wherein local branches of the user's favorite businesses/preferred stores 291, 293 are displayed on a map 205 presented to the user on the communication device 203. The present invention makes it possible for a user to specify his preferred/favorite businesses 287, such as banks, grocery stores, pizza joints, movie theatres, etc. and a social interaction system 285 (which is in one embodiment a GPS based navigation system) displays, on the communication device 203, a nearest branch of those businesses/stores as icons 295, 297 on the map 205 as the user drives while using the communication device 203. The store preferences/business favorites can be specified locally in the device and stored there, or created as part of a profile at a social interaction system 285 or another website/portal. For example, the social interaction system 285 stores the user's favorite businesses in a user's favorite businesses database 287. The store preferences/favorite businesses for the user is downloaded from the social interaction system 285 or otherwise accessed (frequently or as needed) to display the current locations of branches of those stores when requested by the user, such as when the user activates a button ‘show favorite businesses’ 249 on the communication device 203.

For example, at a new city visited by a user of the communication device 203, the device would display the location of a closest branch of the user's bank 291 and grocery store 293 on a map 205 on the communication device 203, employing graphical icons 297, 295 respectively to represent them on the map 205. The communication device 203 provides buttons to select one or more of these businesses to activate navigation to those banks or stores, or to interact with them over a messaging system or using audio information. For example, show favorite businesses' 249 on the communication device 203 can be used to show the user's favorite businesses in order to let the user navigate to them or interact with them. Thus, if a user were to travel with his communication device 203 to a new city, the communication device 203 would automatically display a local branch (based on their location in that city) his favorite bank, stores, businesses, etc. at the new location, thereby making it possible to the user to not only find out their proximity but also easily navigate to any of them just by selecting one or more of them and activating a “GO” button 277 provided on the communication device 203 along with the map.

In one embodiment, the location of the local branches of a user's preferred businesses and stores is displayed on the map only when the user requests them. For example, an overlay on the map 205 with these store locations is superimposed on the map or otherwise displayed with the map 205 when a user selects a ‘show favorite businesses’ button or selects a radio button choice displayed for the map (such as a preference/options selections). In addition, the user's selection of banks, stores, libraries, etc. are grouped in one or more groups, and the user can have one group or one or more groups selected for display of their local branches on the map based on the user's current location. In a related embodiment, the user can have one group or one or more groups selected for display of their local branches on the map 205 based on the user's selection or specification of a target location, which is different than the user's current location. The communication device 203 displays the local branches on the map 205 while centering on the target location, i.e. show the local branches and stores 295, 297 (if such local branches exist), say within a 20 miles zone around the target location specified by the user. In a related embodiment, alternates banks and stores of the same type are identified and displayed on the map if the user's favorites or user preferred ones are not in proximity, such as within 20 miles or so, as specified by the user or set as a configuration. For example, if BankA is not in proximity (say within 10 miles) an alternate back, such as BankB is identified, that is determined to be closest to the user or the target location in general) and displayed on the map. In addition, when the user's favorites (stores, banks, restaurants, etc.) are displayed on the map 205 or displayed in a list with distances, addresses and other information displayed, the user can select one of them, such as the bank represented by the icon 295, and request that more such businesses or stores also be displayed on the map or listed in a display list. The user can select one of them and activate navigation to that selected business or store (such as by activating the Go button 277. The user can also communicate that location and other details of that business to another user employing a different device that is capable of receiving such information and navigating to a location. The user can select multiple businesses, such as a bank and a grocery store from the display, and save them for subsequent use. The user can also select them in some order and plan a rough route and the device creates new route for the user incorporating the selected businesses and the current location of the user/device (or a target location).

If the businesses that a user has grouped together, that get displayed on a map on the user's device provide a service to which the user wants to subscribe or get an appointment for, the user can select the business on the screen and select a “make appointment” button 279 or a menu item (or some user interface widget). For example, a user might select a local branch of his favorite restaurant chain on the map on the device and activate the “make appointment” button 279 which brings up a dialog box prompting the user for a time and the number of people. The user enters a time/date and number of people and a reservation message is communicated to the restaurant and a confirmation is received and displayed. The reservation message is an xml based document sent to a reservation website/server that serves as a reservation front end to the restaurant, in one embodiment. For restaurants that do not have a communication link to the reservation website or is not yet a subscriber to a related service, the reservation message is an audio message communicated to a phone number associated with the restaurant. The restaurant calls back to the user or sends an SMS message to the user to confirm the reservation. The audio message is either recorded by the user dynamically in an adhoc manner on the communication device 203 or a pre-recorded message, such as one that contains the user's phone number.

The communication device 203 is one of a PDA, a converged mobile device, a cellular device, a mobile phone, etc. The present invention provides a non-dangerous mechanism for a user, who might be driving a vehicle, to receive a request on his mobile communication device 203 to accept a destination information, and simply with the click of a button (or by audio means) have it stored for navigation to the specified destination, all without either employing an IM client or even typing text while driving. Instead, the present solution employs audio message request, automatic destination information transfer with user having to type anything, and automatic activation of a navigation software (or sub component/module) to navigate to the received destination. For example, using the audio assisted user request wherein an audio message is received and played by user, and a simple one button click for acceptance (or alternately just by audio response which is used as a trigger), the navigation to the destination information provided is activated, the destination information being provided to the client software in the recipient user's mobile device from the client software in the sending user's mobile device. The client software is capable of receiving an audio request and playing it to the user, prompting the user to accept/approve the destination information, storing the destination information and initiating navigation to the destination information, and also communicating notification when in proximity of the destination or after arrival at the destination (or both).

The present invention supports showing current locations from mobile devices associated with one or more friends list 261 and mapping them on the spatial map 205. It also facilitates subsequent selection by a viewer of one or more individuals (or devices) displayed on the map, such as by drawing a rectangle or another shape using a mouse or a pen based interface, or special keys on a keyboard. This solution goes beyond providing a stationary representation of a vehicle in a roster list, in real-time for the purpose of sending the vehicle's location to other users. This is selection of a new group of individuals based on their current locations, in an fashion, for communicating using audio means in an ad hoc mode, wherein such communication may optionally comprise of transfer of task lists from the selecting individual to the recipients selected from one or more friends lists currently displayed on the map. In general, textual communication with selected friends is cumbersome and even dangerous if the recipients have to reply back in textual format. The present invention provides an alternative to textual mode of communication. By employing an underlying audio-assisted mode of communication, the present invention presents a safe and convenient means of communicating with one or more individuals based on their current location on a map.

The present invention makes it possible for a user to select one or more friends lists (that may already have been created by the user) from a list of friends lists 261. When each of the friends list 263, 265, 267 is selected, the current locations for the members of those selected lists is retrieved and shown on the map 205. This is accomplished, in one embodiment by the client software in the sending device that retrieves current locations from the corresponding client software in all of the targeted mobile devices. In a related embodiment, a server facilitates such retrieval.

The present invention makes it possible to remotely add a POI to a route/trip plan that is currently being followed/used by a user of a mobile device, or by several different users on their mobile devices. Typically, a route planner software enables incorporation of a graphical representation of a location-relevant object, such as POI (i.e., restaurant, gas station, house, user, etc.), to a pre-calculated route itself or to a route planner, thus graphically altering the pre-calculated route by creating a destination point based on the dragged POI's location information. This is done by a user planning a route, often before the start of a journey. However, beyond such static changes, the present invention makes it possible for a different user monitoring the route to add one or more POI, such that all other target individuals currently using that route get their routes updated automatically. In addition, the present invention facilitates automatically viewing current routes of those multiple targets (individuals carrying mobile devices, for example) on a map and interacting with them, such as sending tasks or sending audio messages that is dynamically recorded (and receiving responses back).

The present invention goes beyond a drag-and-drop of an individual user onto a map in order to automatically map the user's current location—it allows selection of one or more lists of friends/individuals/users (groups in general) and automatically showing them on a map on the mobile device (or a web based screen) of a reviewing user (one who is reviewing the map) based on their current locations, wherein the current locations are dynamically retrieved from the associated mobile devices for display on the map.

There is typically no need to send a request to the target users whose current locations are being mapped onto a map by a reviewing user as the target users are expected to provide a consent to the reviewing user when they are included into a friend's list. In addition, they can turn off (by means of a flag that can be easily set on the client software on their mobile devices, for example) in an ad hoc manner the retrieval of their current locations from their mobile devices when they want privacy or do not want to share their location information.

Some prior art solutions support sending a point of interest (POI) information to one or more devices from one device. However, these solutions do not have the support for retrieving a current location from these one or more devices dynamically at run-time, that too based on a current privacy setting of the corresponding targeted user. The present invention facilitates dynamic retrieval of a current location from a plurality of mobile device and subsequent mapping of those location on a map 205 presented to a user.

The mobile communication device 203 that provides the map 205 based user selection and audio communication facilities comprises a computer-readable medium, a processor, a data storage medium, an input unit, and a display unit for providing a graphical interface. It comprises client software that is typically stored in the computer-readable medium that supports interaction with other mobile devices and facilitates communication of location information (such as GPS coordinates), sending notifications, displaying received notifications and triggering and monitoring navigation. The graphical interface comprises a movable graphical pointer for selecting and moving graphical icons displayed on the graphical interface. In one embodiment, it comprises a special keyboard based selection technique wherein specific sections of the graphical interface is selected for specific keys activated on the keyboard (for example, a 1 selected on a mobile phone keyboard selects individuals/mobile devices in a top left corner section of the graphical screen of a map, etc.). The computer-readable medium comprises executable instructions that cause a processor to communicate a message requesting location coordinates from another user using a second mobile device, communicating location coordinates, receiving notifications, displaying notifications, initiating and monitoring navigation, etc. It also comprises executable instructions that cause the processor to execute the steps of: displaying a user graphical icon representing a user or mobile device; displaying individuals from multiple friends list at a time on the map 205 displayed on the graphical interface, employing a user graphical icon representing each user; and in response to a command signal, sending, the current user's location information along with a request to navigate to it to another mobile device, said command signal being generated by moving the graphical pointer to select one or more user icons 207, 209 and activating a Send button 233 (for example). Other means techniques of identifying and communicating the current user's location information are also contemplated.

Some prior art solutions have the ability to rate and conduct a spatial search for one or more points of interest (POI) shown on a map on a device, such as golf courses, restaurants, home addresses, hotels, hair salons, bowling allies, etc., and items associated with various POIs based on a users' current position information. However, these do not and cannot support communication of a current location information from a first mobile device to a second mobile device that facilitates the second mobile device navigating (rather the user of the second mobile device navigating using the second mobile device) to that location and sending a notification to the first mobile device on arrival. The present invention makes that possible, and the current location information need not be a landmark, it is just a current location determined by the first mobile device corresponding to where an associated user is currently located.

Some prior art solutions allow a first user about to travel to plan the trip by using various rating searches or address information to identify various POIs, such as a historical landmark, famous restaurant, etc. Once these various POIs are stored into the first user's navigational device, locally or on an online networked system server, the system would apprise or alert the user when he or she is near these various stored POIs, such as within the POI's city of location or a block away from the POI's location, based on the system's or user's pre-defined notification boundary or range settings. However, these navigational devices, or networked server, or the overall system, do not send automatic notifications to a second device being used by another user who is waiting for the first user to meet him or give him a ride. Thus, the present invention provides automatic notifications that are communicated from the first user's mobile device to the second user's mobile device when the first user is in proximity to a location or POI provided by the second user employing a communication means.

As one of ordinary skill in the art will appreciate, the terms “operably coupled” and “communicatively coupled,” as may be used herein, include direct coupling and indirect coupling, via another component, element, circuit, or nodule where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled” and “communicatively coupled.”

Although the present invention has been described in terms of GPS coordinates and navigational information communication involving mobile phones and computers, it must be clear that the present invention also applies to other types of devices including mobile devices, laptops with a browser, a hand held device such as a PDA, a television, a set-top-box, a media center at home, robots, robotic devices, vehicles capable of navigation, and a computer communicatively coupled to the network.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1. A mobile communication device of a first user in a system that manages communication between the first user and a plurality of friends, the mobile communication device comprising:
communication circuitry;
memory circuitry;
at least one processor communicatively coupled to the communication circuitry and the memory circuitry, the at least one processor operable to, at least:
display on a map based on a current location, when requested by the first user, local branches of the first user's preferred businesses, wherein the preferred businesses are those with whom the first user has an account or relationship previously established and comprises banking organizations, grocery stores, restaurants, libraries, movie theatres and gas stations;
make an appointment or a reservation for the first user with a selected one of the local branches of the first user's preferred businesses;
present to the first user any confirmation received based on the appointment or reservation made for the first user; and
receive directly via a communication network current locations of a plurality of friends and allows the first user to select a subset of them for interactions, wherein interactions with the selected subset comprises sending or receiving at least one of a task, a document, and a content or a reference to a content.

2. The mobile communication device of claim 1 wherein while making the appointment or reservation, the mobile communication device prompts the first user to input at least a preferred time and a number of people.

3. The mobile communication device of claim 1 wherein while making the reservation, the mobile communication device prompts the user for a reservation message, receives the reservation message, and communicates it employing a phone number associated with the selected one of the preferred businesses.

4. The mobile communication device of claim 1 wherein information on preferred businesses for the first user is stored in the mobile communication device.

5. The mobile communication device of claim 1 wherein information on preferred businesses for the first user is accessed by the mobile communication device from a profile of the first user stored at a remote social interaction system or remote website.

6. The mobile communication device of claim 1 wherein the mobile communication device is configured to permit the first user to select a new group of individuals based on their current locations displayed, so as to communicate with those individuals in the new group in an ad hoc manner, wherein the communication comprises transfer of task lists from the first user to the selected new group of individuals.

7. The mobile communication device of claim 1 wherein the mobile communication device is configured to prompt the user for a second user location that is different than the user's current location, and upon receipt of the second user location, displays for the first user local branches of the first user's preferred businesses at the second user location.

8. The mobile communication device of claim 1 wherein the mobile communication device is configured to create one or more friends lists based on instructions from the first user, and further configured for interactions with recipients selected from the one or more friends lists currently displayed on the map based on the current location of the first user and corresponding current locations for the recipients retrieved by the mobile communication device directly from devices currently associated with the recipients.

9. A server in a system that manages communication between a first user using a mobile communication device and a plurality of friends, each of the plurality of using a corresponding remote device, the server comprising:
communication circuitry;
memory circuitry; and
at least one processor communicatively coupled to the communication circuitry and the memory circuitry, the at least one processor operable to, at least:
provide for highlighting on a map displayed by the mobile communication device, based on a current location of the first user, local branches of the first user's preferred businesses, wherein the preferred businesses are those with whom the first user has an account or relationship previously established and comprises banking organizations, grocery stores, restaurants, libraries, movie theatres and gas stations;
receive information related to an appointment or a reservation made by the first user with a selected one of the local branches of the first user's preferred businesses, and communicate it to a computer or server associated with the selected one of the local branches of the first user's preferred businesses;
receive current locations of a plurality of friends of the first user from their corresponding remote devices and subsequently present them to the mobile communication device for display and for interactions; and
communicate, with the selected ones of the remote devices as part of interactions, wherein interactions comprises sending or receiving at least one of a task, a document, and a content or a reference to a content.

10. The server of claim 9 wherein the at least one processor is further operable to, at least:
receive a second user location from the mobile communication device, wherein the second user location is different than the user's current location; and
upon receipt of the second user location, retrieve and communicate for display to the first user local branches of the first user's preferred businesses at the second user location.

11. A method of operating a mobile communication device of a first user in a system that manages communication between the first user and a plurality of friends, the method comprising:
displaying on a map presented by the mobile communication device based on a current location, when requested by the first user, local branches of the first user's preferred businesses, wherein the preferred businesses are those with whom the first user has an account or relationship previously established and comprises banking organizations, grocery stores, restaurants, libraries, movie theatres and gas stations;
making an appointment or a reservation for the first user with a selected one of the local branches of the first user's preferred businesses;
presenting to the first user any confirmation received based on the appointment or reservation made for the first user;
receiving directly via a communication network current locations of a plurality of friends and allowing the first user to select a subset of them for interactions; and
conducting interactions with the selected subset, wherein interactions comprises sending or receiving at least one of a task, a document, and a content or a reference to a content.

12. The method of claim 11 wherein making the appointment or reservation comprises the mobile communication device prompting the first user to input at least a preferred time and a number of people.

13. The method of claim 11 wherein making the reservation comprises:
prompting by the mobile communication device the first user for a reservation message in audio form; and
receiving the reservation message and communicating it employing a phone number associated with the selected one of the preferred businesses.

14. The method of claim 11 wherein information on preferred businesses for the first user is stored in the mobile communication device.

15. The method of claim 11 wherein information on preferred businesses for the first user is accessed by the mobile communication device from a profile of the first user stored at a remote social interaction system or remote website.

16. The method of claim 11 further comprising:
permitting the first user to select a new group of individuals based on their current locations displayed on the mobile communication device;
communicating with those individuals in the new group in an ad hoc manner, wherein the communication comprises transfer of task lists from the first user to the selected new group of individuals.

17. The method of claim 11 further comprising:
prompting the user for a second user location that is different than the user's current location, and
upon receipt of the second user location, displaying for the first user local branches of the first user's preferred businesses at the second user location.

18. The method of claim 11 further comprising:
creating one or more friends list based on instructions from the first user; and
interacting with recipients selected from the one or more friends lists currently displayed on the map based on the current location.

19. The method of claim 11 further comprising:
requesting, by the mobile communication device based on a selection made by the first user, one or more of the plurality of friends whose current locations are displayed on the mobile communication device, to navigate to a selected one of the preferred businesses of the first user for a meeting; and
navigating by the mobile communication device employing a navigation circuitry in the mobile communication device to the selected one of the preferred businesses.

20. The method of claim 11 further comprising:
communicating a current location by the mobile communication device to the remote devices associated with one or more of the plurality of friends whose current locations are displayed on the mobile communication device; and
requesting, by the mobile communication device, the one or more of the plurality of friends to navigate to a selected one of the preferred businesses of the first user for a meeting.
